(19) United States
(12) Patent Application Publication
(10) Pub. No.: US 2003/0018969 A1
(43) Pub. Date: Jan. 23, 2003

(54) Method and system for interactive television services with targeted advertisement delivery and user redemption of delivered value

(76) Inventors: Richard Humpleman, Fremont, CA (US); Dan Watson, Dublin, CA (US); Manu Mehta, Fremont, CA (US)

Correspondence Address: SHERMAN & SHERMAN, Seventeenth Floor, 2029 Century Park East, Los Angeles, CA, 90067, US

(21) Appl. No.: 10/177,232

(22) Filed: Jun. 21, 2002

(51) Int. Cl. H04N 7/025; H04N 7/10; G06F 17/60

(52) U.S. Cl. 725/34; 725/35; 705/14

(57) ABSTRACT

Advertising content is targeted according to demographic viewer information and the viewer response behavior is utilized to further sharpen ad content delivery and for benefit accrual for the viewer. The viewer, after accruing a value account, is invited to redeem the value through purchase discounts and the like.

### CROSS-REFERENCE TO RELATED APPLICATIONS

This application claims the benefit under 35 U.S.C. §119(e) of provisional application No. 60/293,935, filed Jun. 21, 2001.

### BACKGROUND OF THE INVENTION

### FIELD OF THE INVENTION

The present invention lies in the field of business methods and advertisement delivery, electronic systems, and methods for transacting advertising content delivery and redemption between a purchaser and a merchant. The invention relates to an electronic commerce system for handling information in the commerce system, and particularly information concerning preferences and advertisement captivity tendencies of users. More specifically, the invention relates to a business model with direct marketing, with user interaction following advertisement delivery, and with delivery of earned value and credit items. The novel method and system is particularly applicable to interactive networks, and particularly to digital, interactive television systems.

The television broadcast industry is currently in the midst of a complete conversion to a digital format. Digital broadcast systems provide for advanced digital set-tops with local storage. The technological advances allow new generations of interactive television services to be developed. If TV is to become a true dialogue medium, enabled by the response capabilities of interactive software, then advertisers will require opportunities to execute on the full range of marketing strategies and tactics, available to them through other response media, without sacrificing the enormous persuasive appeal of good television advertising. This combination is the true appeal of the “new medium.” What we see in the prior art are many partial solutions and half opportunities, providing one or another marketing function based on a cool technical development, but leaving advertisers searching to find large scale value.

Prior art interactive television (iTV) advertising solutions suffer primarily from being interruptive to the viewer'entertainment experience, greatly reducing the probability of achieving the interactivity they seek to enable. Very few offers will entice a viewer to select or interact with ads in the broadcast stream when viewers are more often seeking to avoid these ads than engage more deeply in them. In the cases where viewers are interested, time is extremely sensitive and strategic execution severely limited. Where ads have been presented within a user interface, such as placed on a channel guide screen, they remain asymmetrical to the viewer'chosen activity and are disparately scattered across multiple pages and time of access. This again, is not conducive to mass participation.

There exist two primary approaches to interactive shopping, or “t-commerce” applications. One is referred to as the “walled garden” model: a sort of mini-shopping mall on television. The second one is to sell “in the broadcasting stream”: that is, sell the viewer something that relates to what they are already watching.

Before delving into the specific features and the required technology of the novel development, the reader should become familiar with various prior and current developments by the assignee, MetaByte Networks Inc. (MNI). They deal broadly with systems and technology for TV Ad and program targeting to specific user profiles and parameters. These developments are also reflected in several prior patent applications, including:

“System and Method for Generating and Managing User Preference Information for Scheduled and Recorded Television Programs,” application No. [60/293,763, filed May 25, 2001 —attorney docket No. MET1.0030b] and the related application “Database Management System and Method for Electronic Program Guide and Television Channel Lineup Organization,” application No. [60/293,763, filed May 25, 2001—attorney docket No. MET1.0030a]. These applications are herewith incorporated by reference.

“System & Method for Targeted Advertising”, a copending patent application describing a DTV or STB payment card or smart card for paying for programs without advertising, where advertising with the program has been refused by the user, and our copending application entitled “System and Method for Behavioral Model Clustering in Television usage, Targeted Advertising via Model Clustering, and Preference Programming Based on Behavioral Model Clusters,” based on provisional application No. 60/260,745. The copending applications are herewith incorporated by reference.

“Television Program Recording with User Preference Determination,” application Ser. No. 09/096,592, which is herewith incorporated by reference.

The copending, earlier applications “Logic Operators for Delivery of Targeted Programming”, and “Improved Logic Operators for Delivery of Targeted Programming,” describe targeting metadata attached to a TV program or other content for the purpose of targeting it to certain users that satisfactorily match certain criteria detailed therein. Example criteria include program content types, input or inferred demographics, products, universal product codes (UPC) and industry type codes, whereas extended system architectures for explaining how such product code information might arrive in the STB equipment was, at the time, not provided. The copending application is herewith incorporated by reference.

Of particular interest is our concurrently filed, copending application entitled “Method and System for Electronic Purchases Using an Intelligent Data Carrier Medium, Electronic Coupon System, and Interactive TV Infrastructure,” Application No. [Attorney Docket No.

MET1.0032], which is based on the same provisional application as the instant application and which is herewith incorporated by reference. Our copending application contains technical details concerning the smart card and the e-coupon systems that are also important in the context of the instantly described model.

### SUMMARY OF THE INVENTION

It is accordingly an object of the invention to provide a method and system for interactive television services with targeted advertisement delivery and user redemption of delivered value, which overcomes the above-mentioned disadvantages of the heretofore-known devices and methods of this general type and which improves direct marketing systems without becoming more intrusive to the viewer than necessary.

With the foregoing and other objects in view there is provided, in accordance with the invention, a method of targeting advertising content in a television broadcast system. The method comprises:

providing a broadcast supply of targeted advertising content in a television broadcast system and supplying the advertising content to a television user;

automatically selecting from the broadcast supply of targeted advertising content a user ad content matching a user profile, and storing the user ad content;

presenting program portions from the ad content to the user in accordance with the user profile; and

crediting the user for being presented the ad content.

In accordance with an added feature of the invention, the user controls the presentation of the ad content.

In accordance with an additional feature of the invention, the crediting step comprises increasing a value of a value counter (in an accrual system) when the user displays the ad content, and associating given advertisements with a given merchant. Preferably, the value or a partial value defined by the value counter is redeemed by the merchant, and the value counter is reset upon completing the redemption. According to the invention, the redemption may be an online transaction between the user and the merchant or a transaction between the user and the merchant at the merchant'store (brick and mortar transaction).

With the above and other objects in view there is also provided, in accordance with the invention, an electronic commerce system, comprising:

a broadcast system server for providing a supply of broadcast content and a system operator connected to the broadcast system server for assembling a broadcast stream;

an advertising server supplying advertising content;

a user device (DTV/STB) connected to receive the broadcast stream and, independently from the broadcast stream, receiving and cache-storing targeted ad content received from the advertising server.

In accordance with a further feature of the invention, the user device is a digital device programmed to select from the broadcast stream targeted ad content according to a given user profile. The user profile may be demographic information that has been assembled by the user device or that has be input.

With the above and other objects in view there is also provided, in accordance with the invention, a virtual sales representative for attracting a consumer to merchant, comprising:

an advertisement server connected to a broadcast system server to supply to a user advertisement content;

a benefit accrual system responsive to user action in response to the ad content; and

a redemption agent for selectively interacting with the user to enable the user to redeem value from the benefit accrual system from the merchant.

In accordance with again an added feature of the invention, the redemption agent is programmed to prompt the user to appear at a physical shop operated by the merchant.

In accordance with again an additional feature of the invention, the redemption agent stores accrued incentives on an intelligent data carrier medium via interactive television (DTV/STB) equipment. In accordance with a preferred feature of the invention, the intelligent data carrier is encrypted with a standardized public key, and carries a double-signature.

The novel system proposed herein is a loyalty rewards application intended to provide business advantages to multi-system operators, similar to rewards redemption programs established in other industries. The system provides incentives, in the form of points, for TV viewers who interact with advertisements and engage in t-commerce activities that have been aggregated and presented within a walled garden application format. Value points are redeemable for goods and services provided by the operator and official application partners, such as airlines and credit card programs. The system is intended to encourage opt-in behavior by TV viewers who otherwise may be wary of profiling technologies developed and deployed for the purpose of the targeted marketing of television ads and content. The application augments the collection of TV viewing behavior data with product interest and purchase related data provided in exchange for the discounts and rewards offered by the system.

Other features which are considered as characteristic for the invention are set forth in the appended claims. Although the invention is illustrated and described herein as embodied in a method and system for interactive television services with targeted advertisement delivery and user redemption of delivered value, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

FIG. 1 is a block diagram illustrating various menu-driven screens of a graphical user interface (GUI) according to the invention;

FIG. 2 is a block diagram showing a user interface navigation diagram corresponding substantially to the block diagram of FIG. 1 and with slightly more specific category descriptions;

FIG. 3 is a system block diagram illustrating the functional interrelationships between the various system components;

FIG. 4 is a schematic diagram of an e-coupon data structure; and

FIG. 5 is a schematic diagram of an e-coupon data structure according to the invention.

### DESCRIPTION OF THE PREFERRED EMBODIMENTS

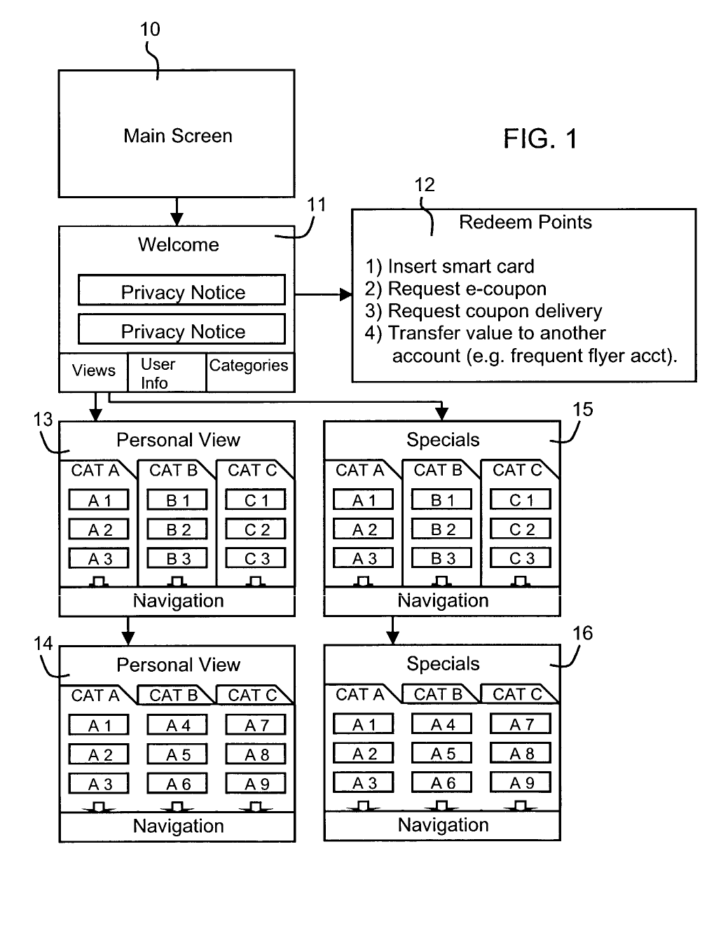

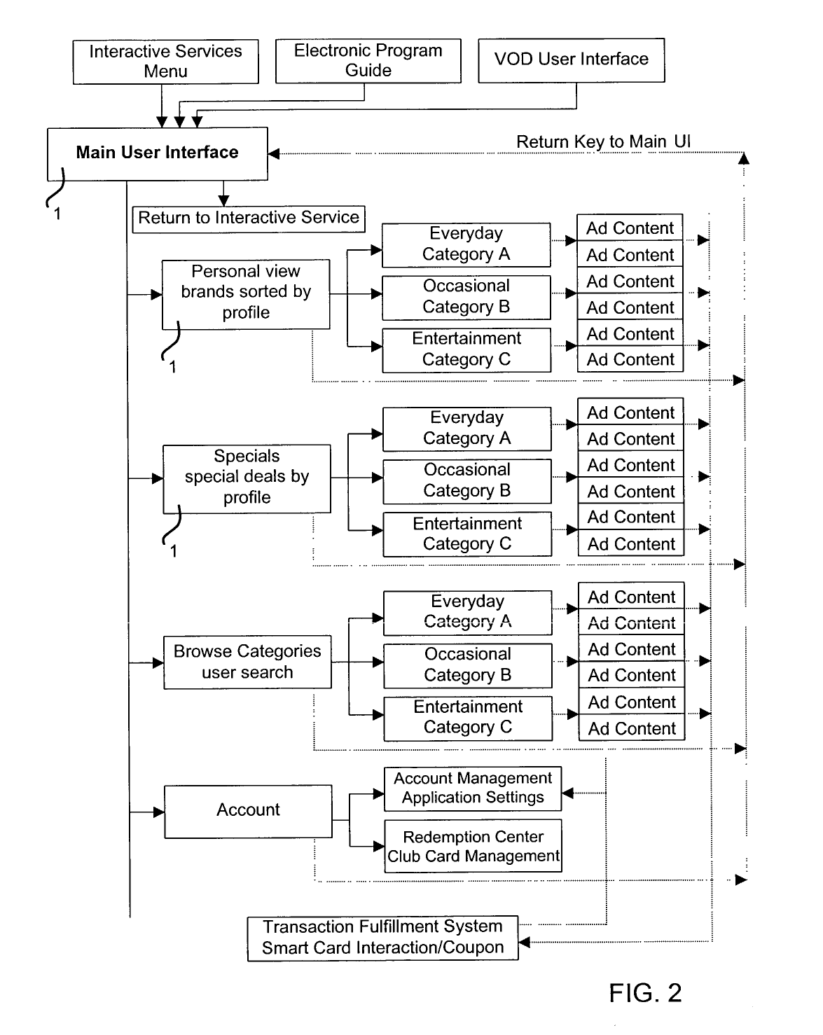

Referring now to the figures of the drawings in detail and first, particularly to FIGS. 1 and 2 thereof, there is shown a block diagram with various GUI (graphical user interface) screens. The user interface is an example of a menu-driven set of screens providing the user access to the loyalty rewards service according to the invention. That is, the user accesses the loyalty rewards service by running the loyalty rewards application GUI on a user device (PVR). The content is delivered by the loyalty rewards system. Typically, the rewards (e.g., ad coupon accrual) content is delivered via a broadcast television electronic communications system. The delivery, however, is independent from other TV services.

Upon accessing the system from within an operator's interactive service menu, the user is faced with a static main screen 10, or introduction screen, from which the user reaches a menu screen 11 upon clicking any input button. The menu screen 11 provides various fields, including a privacy notice, a point redemption menu, and a static or dynamic navigation bar. The screens 10 and 11 thus represent a top level service or main user interface. The main user interface provides three navigational options that the viewer can choose in order to access and sort ad content; a personal view, deals, and a browser for various categories. From this interface, the viewer can also select a redemption screen 12 to access account information as well as browse rewards from application partners. The viewer will also find a link to an application tutorial and privacy policy.

From the top level user menu, the user enters into the personalized screen, the personal view screen 13, which presents the viewer with a selection of targeted brand billboards. Brands are selected and presented in order of relevance to the household profile.

In the navigation menu, content is navigated by the transactional category columns. Here, we illustrate three categories A, B, C, which each contains various fields, displayed as banners or billboards, A1, A2, A3 . . . B1, B2 . . C2, C3. By indicating a preference in more content of a particular transactional type (More Choices), the viewer is presented with additional brands of this type. More content of one transactional type is further explored by scrolling (Back, Next) through multiple page displays.

The various billboards display opportunities to explore recommended brands. Display priority is determined by a combination of viewer relevance, content targeting rules and campaign fulfillment requirements. Preference determination which applies to the system is organized in accordance with our above-noted co-pending patent applications.

Screen Access: All areas of the application can be accessed at any time. The Universal Navigation Bar makes each application section available, while Transactional Category Columns give the viewer immediate access to every type of advertiser and offer.

In a separate screen 15 entitled specials, or deals, the user is presented with a selection of targeted billboards which highlight special offers, further sorted by transactional type; everyday, occasional and entertainment. The offers have been selected and presented in order of relevance to the household profile. By indicating a preference in browsing more content of a particular transactional type, the viewer is presented with additional offers of this variety.

Purpose: Present viewer with a selection of targeted brand billboards. Brands are selected and presented in order of relevance to the household profile.

The screen 15 is once more organized in three elements:

Screen Title Indicator—Indicates present content section and content sorting priority.

Transactional Category Columns—Allows the viewer to indicate sorting preference by transactional type;

category A=everyday purchases (Everyday), category B=occasionally purchased items (Occasional); and category C=entertainment related purchases (Entertaining).

Universal Navigation Bar—Presents application sorting options as targeted brands (Personal View), featured deals (Special Deals) and search features (Browse Categories). Provides link to application settings, rewards information and privacy statement. Displays upto-the-minute ticker with a tally of the accrual of value points earned.

Navigation Menu: Content is navigated by the Transactional Category Columns. By indicating a preference in more content of a particular transactional type (More Choices), the viewer is presented with additional brands of this type. More content of one transactional type is further explored by scrolling (Back, Next) through multiple page displays.

Screen Content: Billboards display opportunities to explore recommended brands. Display priority is determined by a combination of viewer relevance, content targeting rules and campaign fulfillment requirements.

Screen Access: All areas of the application can be accessed at any time. The universal navigation bar makes each application section available, while transactional category columns give the viewer immediate access to every type of advertiser and offer.

A further option provided to the user is a menu entitled “browse categories,” where the viewer is presented with three ways to search for promotional content; by category, keyword or participating brands A-Z. Each search option is further sorted by transactional type, categories A, B, C (e.g., everyday, occasional, and entertainment). Selecting a category will display content for that category from within the transactional type indicated. Entering a keyword will present content matches from all transactional types. Finally, selecting a brand from A-Z will directly launch content associated with the chosen brand.

A further menu-driven screen is provided with information concerning account management. These include account information, rewards redemption, privacy policies, tutorial information and application settings. At a screen 12, viewers can redeem operator incentives or transfer system points to participating rewards programs. The list illustrated in the box 12 is neither all-inclusive nor exhaustive. For instance, one possibility of redeeming value is by downloading negotiable value to a portable smart card or an e-coupon. Specific information concerning these portable media can be found in our copending application No. [attorney docket MET1.0032]. A further possibility is to have a paper coupon delivered by mail directly to the house or to a given merchant for later redemption. Depending on the number and depth of participating merchant members, it may also be advisable for the user to transfer points to another value system, such as a frequent flyer program.

Content for the application is comprised of billboards, buttons, video and customizable interactive pages. Advertisers can choose from several page templates to populate with branded content. The application automatically links content from among each advertiser'pool of assets, in order to present the appropriate targeted stream to suit a household profile. Each time a viewer accesses the application, the system determines which billboard, spot, page, buttons and additional video assets to link, assemble and present for consumption. This determination is 'based on a match of the targeting parameters set by the advertiser and the data contained in each household's profile. Specific information concerning household profile generation and preference determination is found in several of the above-quoted copending patent applications and will not be repeated here for reasons of clarity and to avoid a prolix specification.

### EXAMPLE 1

The first example is based on a sample campaign for Volkswagen® and, specifically, for a group of local dealers. A coupon strategy is used here for generate leads and drive store traffic. The viewer is offered $100 dollars for taking a test drive of Volkswagen'new Turbo Bug. Only those viewers who closely match the targeting parameters of this promotion will receive the offer. Coupons create an effective incentive to purchase for those to whom a product is well suited and an offer well timed. $6 Billion is spent annually in the U.S. in order to distribute 36 billion coupons. With great room for improvement, “successful” coupon campaigns attract 2-3% response rates.

Screen content is presented through a template with three components: universal navigation bar, main offer and links to additional related content. The universal navigation bar is always present except during the presentation of video content. Links provide access to additional video messages or product information and offers.

The system recognizes the user and automatically provides information about the nearest dealership. Links are provided on each screen so that the viewer may access additional content related to Volkswagen automobiles and purchasing assistance. All content pages are embedded with a “Back” button, allowing the viewer to return, at any time, to the content navigation page where the ad originated.

When the offer has been accepted, Volkswagen provides a confirmation and an application sound indicator tells the viewer that points have been earned, with the increase presented on the system point ticker. However, with coupon strategies, conversion of the offer has more value than acceptance. A portion of the points are earned with acceptance, and an additional, greater amount are earned when the application is notified of conversion, that is, when the user has visited the advertising dealership and has, possibly, taken a test drive.

### EXAMPLE 2

The second example is based on a sample campaign for Swiffer®. A Sweepstakes strategy is used in this campaign, offering viewers a chance to win free maid service for one year in exchange for providing personal contact information and product interest responses. Sweepstakes are an effective mechanism for generating purchase related, decision-making data, lead generation and brand awareness.

Screen content is presented through a template with three components: universal navigation bar, main offer and links to additional related content. The universal navigation bar is always present except during the presentation of video content. Links provide access to additional video messages or product information and offers.

This template facilitates multiple page surveys and data collection. The system recognizes the user and automatically populates name and address information. Pull down menus and arrow navigation promotes an easy to use format. Links are provided on each screen so that the viewer may access additional content related to Swiffer products. All content pages are embedded with a “Back” button, allowing the viewer to return, at any time, to the content navigation page where the ad originated.

Upon submitting the final entry, Swiffer provides a confirmation page and an application sound indicator tells the viewer that points have been earned, with the increase presented on the Money-Bag™ point ticker.

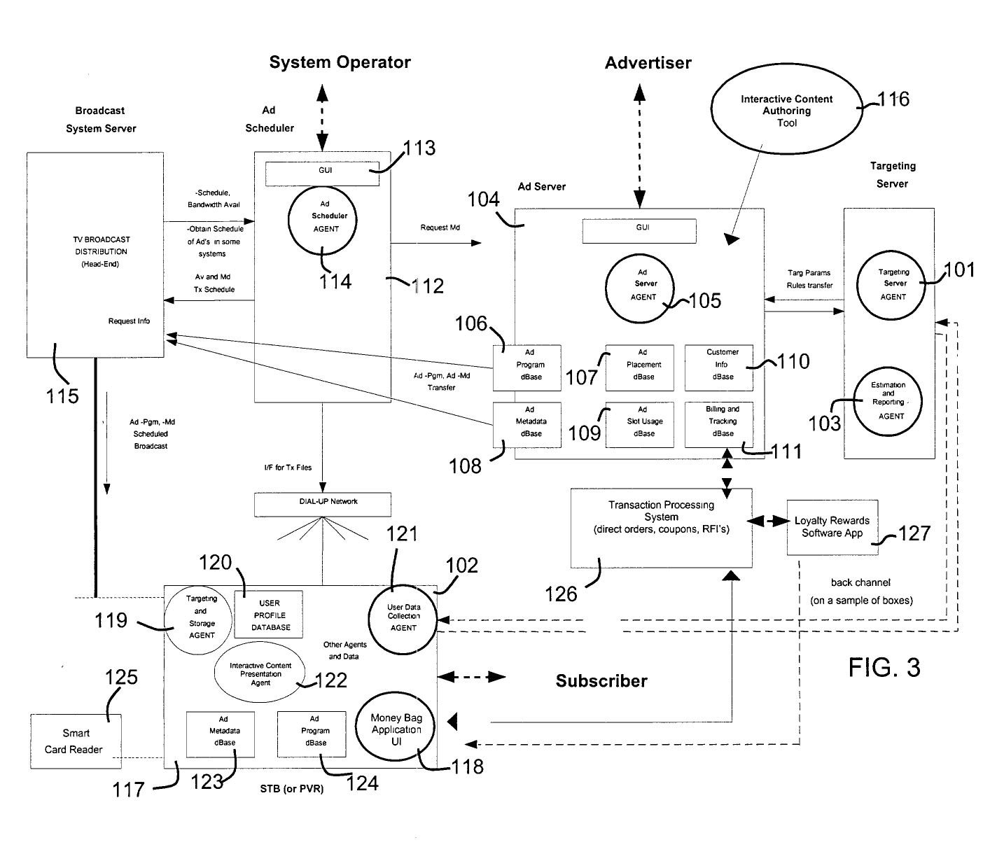

As noted above, various possibilities exist for value redemption. One possibility is to utilize a smart card based offer redemption system. While using the application, viewers must insert a smart card into the designated slot on the set top box. The smart card records all offers downloaded by the viewer and transmits the savings to in-store point of sale devices. At point of sale, this smart card also records all sales activities related to the application offers, and, upon re-inserting in the set top box, uploads conversion information back to the application, in order to award additional points earnings based on these activities. This is similarly true for an e-coupon system, in which a data carrier is loaded with redemption value information and security is assured with double-signature digital encryption. Referring now to FIG. 3, there is illustrated a system block diagram which describes the hardware and software required in the context of the novel system.

Three primary players are involved in the system, namely, a system operator, an advertiser, and a user. A targeting server agent 101 is a module that analyses viewer data collected through user data service or third party data monitoring system 102 and creates rules to assist demographic profiling. A further module in the targeting server, namely, an estimation and reporting agent 103, analyses viewer data collected through the user data service 102 or third party data monitoring system and forms reports to answer software queries regarding consumer usage.

The ad server 104 is the module group associated with the advertiser. The ad server includes an advertiser'GUI—This set of screens allow an advertiser or an operator acting on behalf of the advertiser to insert ad content and information related to the placement of these ads. These screens also allow an advertiser to monitor the progress in presentation of previously submitted ads.

The ad server agent 105 module periodically updates the status of ads already presented by interfacing with the reporting agent. This module 105 also updates billing information corresponding to ads presented. An ad program database 106 stores ad content. Ad content may include audio, video and data. The database 106 also contains information about these ads.

An ad placement database 107 stores information about ad placement requests, and an ad metadata database 108 stores metadata information about ads. The database 108 is created from the ad placement database 107 and the ad program database 106. A scheduling engine uses this database to generate schedules and to create meta-data modules.

An ad slot usage database 109 stores information about slots available in different channels to place ads. A customer information database 110 stores information about advertisers using this system. A billing and tracking database 111 stores information about billing and accounting activities corresponding to ads placed.

The system further includes an ad scheduler server 112. The server 112 contains an administrator'GUI 113. The GUI is a set of screens allowing administrators to control creation of meta-data modules and schedules for transmission of meta-data modules and ad content. The module 113 also allows an operator to modify information regarding the slots available for content and metadata transmission. An ad scheduler agent 114 periodically generates meta-data modules and schedules for the transmission of metadata modules.

To the far left of FIG. 3 there is illustrated a broadcast system server (head-end) 115. The server 115 is a typical broadcast system head-end that can broadcast audio/video content and data.

An interactive content authoring tool set 116 contains tools that can be used to create ad content.

The user side contains a digital set-top box STB with local storage or a PVR 117. The novel system provides for the special loyalty rewards application and the user interface 118, which operates with the smart card 125 to securely manage, i.e., receive, issue, accrue, and redeem the value amounts, points, or coupons. The loyalty rewards application 118 also cooperates with the user controlled presentation agent 122 and organizes the various screen displays explained with reference to FIGS. 1 and 2, including making specific ads available (and other ads unavailable) to the user for selection via the GUI that offer a coupon or reward points based on the user profile information including usage information from usage of previously earned coupons or transactions. A targeting and storage agent 119 is the component of the novel system that looks at the metadata library and decides to download relevant content. This module also makes decisions on what content to delete from storage.

A user profile database 120 stores information about viewers'past interactions and the inferred demographic profile of the viewer. A user data collection agent 121 collects information about viewer interaction with the TV. This information is periodically uploaded to a server. An interactive content display agent 122 is the presentation engine used to display interactive content as directed by user commands. An ad metadata database 123 stores content metadata, and an ad program database 124 stores ad and program content.

In one embodiment of the invention, as noted above, the value delivery and redemption is effected via smart card download. The download is enabled by a smart card reader 125 via a connection port, an interface used to read and write data from and to a smart card. The smart card reader 125 is an external smart card reader connected to the set-top box. A smart card is inserted to collect and store special offer information and coupons selected by the viewer for redemption at point of purchase. This reader also receives purchase and coupon conversion information, stored on the card after purchases have been made, updating the loyalty rewards application on points accrual.

A transaction fulfillment system 126 is a third party system that takes purchase orders and RFIs (requests for information) and processes them. A loyalty rewards application 127 collects information about viewer interaction with the novel system, and viewer purchases, and computes loyalty rewards. In the exemplary best mode embodiment, the system uses loyalty rewards application 118 in conjunction with the Smart Card 125 to securely manage the value amounts, points or coupons.

This loyalty rewards application 127 is based at the service operator and may be in place of the loyalty rewards application 118 and smart card 125 in the user device (PVR) 102. The application 127 is connected to users via, and cooperates with, the on-line TV commerce transaction system 126 for relevant communication i.e. related to 127 type loyalty rewards value amount user interactions.

This alternative system uses two-way communications from the user device 102 to the service operator system loyalty rewards application 127 to remotely manage the value amounts or loyalty points issued to each user and their accounting. Therefore for example American Airlines points accrued are automatically transferred to the user'AA rewards account. However, this communications and server alternative is not cost effective for managing small value amounts like points and coupons whereas the smart card is.

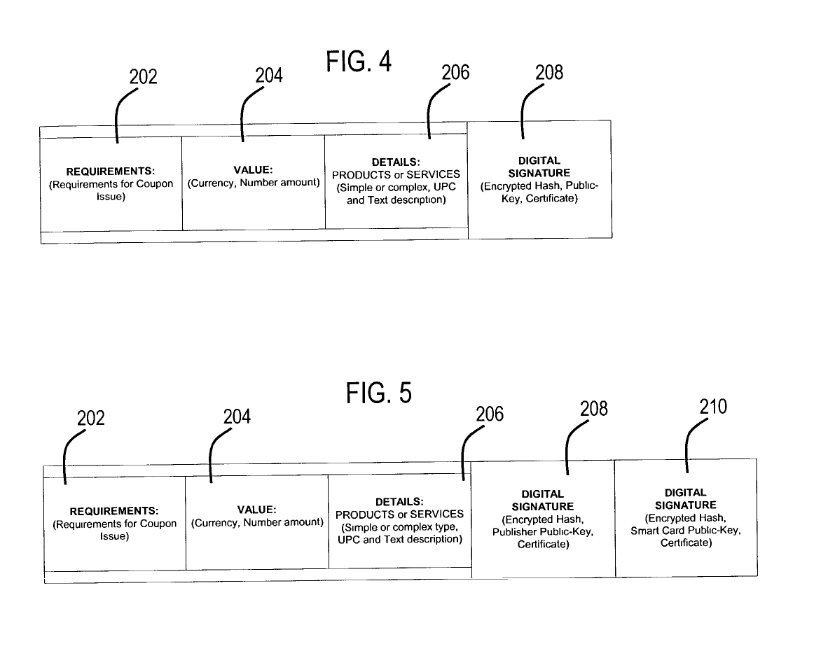

Mention has been made above of the e-coupon. The better explain the e-coupon system proffered herein, reference will now be had to FIGS. 4 and 5. FIG. 4 shows the format of an original E-Coupon as published and distributed. Incentive accounts employ Universal Product Code (UPC) descriptor code numbers, which are already standardized, to define manufacturers and products. They are also used to describe discounts pertaining to a manufacturer, an individual or a family of products and a coupon value. Sometimes, a simple UPC type coupon is all that is required; other times, a more complex combination incentive coupon is required, which is described using multiple UPCs and Boolean operators.

The REQUIREMENTS field 202 for coupon issue include a registered UPC number with code numbers (in product number position) or otherwise standardized text or code to indicate the coupon issue terms, including coupon campaign start and end time and date, ad impression, ad interaction, double-interaction, purchase made at STB and no terms free to all viewers.

The VALUE 204 of coupon may include money ($) or any other currency or other units of value (e.g., airline frequent flier type mileage).

Referring to the DETAILS field 206 of coupon, coupon may be simple or complex (i.e., Boolean), as shown below. Text description is also required (in addition to a UPC) in order to display the coupon information to the user at any time. Without the text, the DTV/STB 4 should have a cross-reference library or access to a cross-reference library.

SIMPLE COUPON: (UPC of Manufacturer, Product or family, also text description).

COMPLEX COUPON: (UPC of Manufacturer, Product or family, also text description)

AND

(UPC of Retail-store or other entity, also text description), etc.,

The e-coupon may be transmitted via a broadcast type TV system and can be encoded as program or content metadata using XML Schema. A number of “industry standards” bodies (e.g., TV-Anytime and MPEG-7) define TV program and content description metadata using XML Schema. The coupon description can be coded using the same style and can be a metadata addition.

The XML Schema standard also allows an extendable Boolean description (for a simple or complex coupon).

E-coupons are transmitted from the manufacturer or system operator. The coupons or discounts are not internally generated. The account agent reads the coupon requirements, follows the monitored user interactions and verifies that the appropriate conditions are met, and if affirmative, registers the coupon with a removable smart card of the system (see copending application MET1.0032) or the user is given the option of paper delivery of such a coupon. Part of this process may be verifying the coupon (using the digital signature) for the DTV/STB 4.

The e-coupon set of information is not encrypted, but is accompanied by an originator'or publisher'digital signature 208 using PKI technology to ensure that the information (including the UPC') has not been tampered with (at any place or in transmission involving broadcast and data networking). The digital signature 208 includes an encrypted hash of the coupon and the coupon originator'public key so that any party can validate the coupon contents by decrypting the hash sent and comparing it against a re-hash of the coupon.

The digital signature 208 can be used to validate the e-coupon at any stage, but an additional security step (which is equivalent to the paper coupon cutout and redemption) should take place to make the e-coupon unique at the earning or issue stage and prevent copying fraud (later in the coupon collection and refund chain).

The e-coupon has the originator (publisher) digital signature 208 to permit coupon details to be checked to be tamper-free and (at issue) has a second digital signature 210 attached by the user's system, making the used-coupon unique and thus preventing duplication fraud in the collection and refund stages. Use of the digital signatures allows the coupon to also be used at an Internet-connected home PC or any network connected terminal or point-of-sale location.

Coupon manufacturer/product/value details use existing codes (e.g., UPC) and a text description to allow the user to be informed of the details. Complex e-coupons involving a combination of a product/store (e.g., a particular supermarket chain and a particular product) can be described and delivered.

E-coupon copying fraud prevention is provided by generating a second digital signature 210 (with unique public key as shown in FIG. 5) using its own private key, thus making the redeemed coupon (which is the original coupon together with a user system generated digital signature 210) unique. Accordingly, the e-coupon uses double digital signature. The first signature 208 validates the coupon and the second signature 210 validates the use of the coupon.

Moreover, the digital certificate can be verified to check whether it is from a valid user (typically, via Internet communications) at any later collection, clearing and refund stages. A unique redeemed coupon with user system validation is a candidate for coupon value refund to the POS store or entity by the coupon originator, although other business entities may also qualify to retain a percentage.

We claim:

1. In a television broadcast system, a method of targeting interactive advertising content, which comprises:
providing a broadcast supply of targeted advertising content in a television broadcast system and supplying the advertising content to a television user;
automatically selecting from the broadcast supply of targeted advertising content a user ad content matching a user profile, and storing the user ad content;
presenting program portions from the ad content to the user in accordance with the user profile; and
crediting the user for being presented the ad content.

2. The method according to claim 1, wherein the presenting step is controlled by user input.

3. The method according to claim 1, wherein the crediting step comprises increasing a value of a value counter when the user displays the ad content, and associating given advertisements with a given merchant.

4. The method according to claim 3, which further comprises redeeming the value or a partial value defined by the value counter by the merchant, and resetting the value counter upon completing the redemption.

5. The method according to claim 4, wherein the redeeming step comprises an online transaction between the user and the merchant.

6. The method according to claim 4, wherein the redeeming step comprises a transaction between the user and the merchant at the merchant'store.

7. An electronic commerce system, comprising:
a broadcast system server for providing a supply of broadcast content and a system operator connected to the broadcast system server for assembling a broadcast stream;
an advertising server supplying advertising content;
a user device (DTV/STB) connected to receive the broadcast stream and, independently from the broadcast stream, receiving and storing targeted ad content from the advertising server.

8. The electronic commerce system according to claim 7, wherein said user device is a digital device programmed to select targeted ad content according to a given user profile.

9. The electronic commerce system according to claim 7, which further comprises a device for crediting a given user value points for selected interactions with the targeted ad content.

10. A virtual sales representative for attracting a consumer to a merchant, comprising:
an advertisement server connected to a broadcast system server to supply to a user advertisement content;
a benefit accrual system responsive to user action in response to the ad content; and
a redemption agent for selectively interacting with the user to enable the user to redeem value from the benefit accrual system from the merchant.

11. The virtual sales representative according to claim 10, wherein said redemption agent is programmed to prompt the user to appear at a physical shop operated by the merchant.

12. The virtual sales representative according to claim 10, wherein said redemption agent stores accrued incentives on an intelligent data carrier medium via interactive television (DTV/STB) equipment.

13. The virtual sales representative according to claim 12, wherein said intelligent data carrier is encrypted with a standardized public key, and carries a first digital signature and a certificate.

14. The virtual sales representative according to claim 13, wherein the data carrier also carries a second digital signature.

15. A computer-readable medium having stored thereon a data structure for operating the benefit accrual system and the redemption agent according to claim 14.

16. A general merchandize promotion and commerce service method, which comprises:
delivering personalized television content via a television communications system and via a user controlled presentation application on a first user device;
maintaining the presentation application in a normally off mode;
running the presentation application upon user command independently of other television services and thereby not offering the user control over a choice of a provider for the service in the presentation application;
electronically accumulating credits from using the service and conveying credits to a merchant for redemption; and
controlling a selection of the personalized television content delivered to each user based on information from usage of the first user device and from the conveyance of the credits to the merchant.

17. The method according to claim 16, which comprises conveying the credits to the merchant with a second user device and controlling the selection of the personalized television content based on the usage of the first user device and the second user device.
